(19) United States
(12) Patent Application Publication
(10) Pub. No.: US 2010/0293176 A1
(43) Pub. Date: Nov. 18, 2010

(54) RANGE INCLUSIVE PROBE ALGORITHM

(75) Inventor: Anatoly Burukhin, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/465,370

(22) Filed: May 13, 2009

(51) Int. Cl. G06F 17/30

(52) U.S. Cl. 707/759; 707/769

(57) ABSTRACT

A range inclusive probe algorithm for searching sorted, partially sorted, or unsorted data arrays is provided. The range inclusive probe algorithm begins like a binary array searching for a value with interactive range reduction. The search is continued even if the value is not found during the initial pass applying the same technique to the remaining ranges if the array is unsorted. Every element of the array may be checked once if the sought value is not in the array, but due to the binary approach at the beginning, search speed is higher than a linear search.

### BACKGROUND

Search algorithms are an integral part of many computer applications. Software typically consumes data, which may or may not be structured. During the execution of an application, the data is accessed, modified, added or deleted. Thus, the application needs to find particular portions of data at various steps of the execution. The search may be a part of the execution not visible to a user, or it may be directly derived from a user request.

For example, a user of a desktop application such as a word processing application may activate a “find” command looking for a particular word or phrase within a document. A search algorithm is executed sorting through the data to present the user occurrences of the sought word or phrase. Another example of using a search algorithm in a common software application is performance of a computation within a spreadsheet application. Spreadsheet applications are used to store, format, and analyze data in a spreadsheet format. If a user requests the computation of an average of data values with a common attribute (e.g. sales figures for a particular product in different geographical locations), the spreadsheet application first searches for those data values, then performs the averaging computation.

Some search algorithms are fast, but they may not work with different structures of data. For example, binary search is a rapid method of searching through sorted arrays. Thus, binary search is not as useful when the data is unsorted or semi-sorted. Other search algorithms may cover a wide range of data structures, but they are typically too slow and may affect a user's experience with a software application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a range inclusive probe algorithm for searching sorted, partially sorted, or unsorted data arrays. The range inclusive probe algorithm begins like a binary array searching for a value with interactive range reduction. The search is continued even if the value is not found during the initial pass applying the same technique to the remaining ranges if the array is unsorted.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example binary search through a structured data array;

FIG. 2 is a flowchart of an example binary search algorithm that fails, when the data is unsorted;

FIG. 3 illustrates a flowchart of a range inclusive probe search process according to embodiments;

FIG. 4 is an example table illustrating lookup of an element with value “0” in a list of 10 integers employing a range inclusive probe algorithm according to embodiments;

FIG. 5 is a networked environment, where a system according to embodiments may be implemented; and

FIG. 6 is a block diagram of an example computing operating environment, where embodiments may be implemented.

### DETAILED DESCRIPTION

As briefly described above, a range inclusive probe algorithm may be employed to perform fast searches through sorted, partially sorted, and unsorted data. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “server” generally refers to a computing device executing one or more software programs typically in a networked environment. However, a server may also be implemented as a virtual server (software programs) executed on one or more computing devices viewed as a server on the network. More detail on these technologies and example operations is provided below. The term “client” refers to client devices and/or applications.

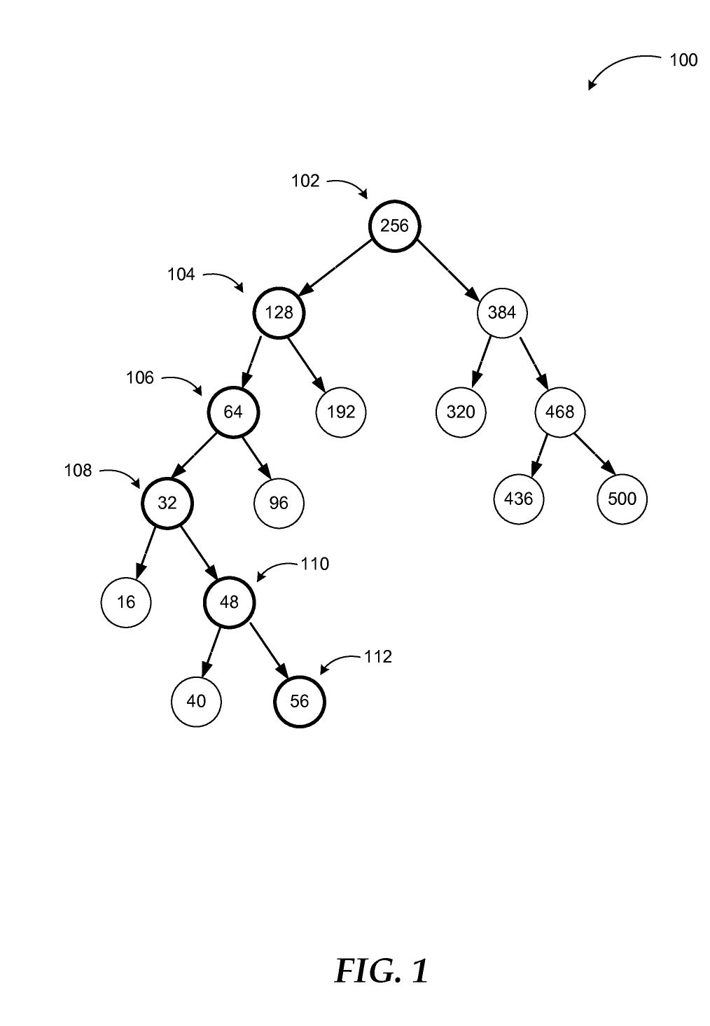

Referring to FIG. 1, an example binary search through a structured data array is illustrated in diagram 100. As discussed previously, search algorithms are part of many software applications. Complexity and approach of search algorithms vary depending on their purpose, speed requirements, complexity, and similar characteristics. Some search algorithms are fast, but they may not work with different structures of data. Other search algorithms may cover a wide range of data structures, but they are typically too slow and may affect a user's experience with a software application.

List search algorithms are a basic kind of search algorithm. They are designed to find one element of a set by a key. One of the simplest forms of list algorithms is linear search, which examines each element of the list in order. It has expensive 0(n) running time, where n is the number of items in the list, but can be used directly on any unsorted list. A relatively more sophisticated and faster list search algorithm is binary search. Binary search is also a special case of a tree search algorithm, which perform the search through a data set in a tree structure. Binary search runs in O(log n) time. This is significantly faster than linear search for large lists of data, but it requires that the list be sorted before searching.

The basic binary search illustrated in diagram 100 begins in the middle point of an array (102). The array is divided into binary segments and the search performed at each stage in the binary segments until the sought value is found (or not). In the example diagram the search follows the elements 104, 106, 108, 110, and 112, where the sought element is found. Again, while the search is rapid, the elements have to be sorted in order for the search to be successfully performed.

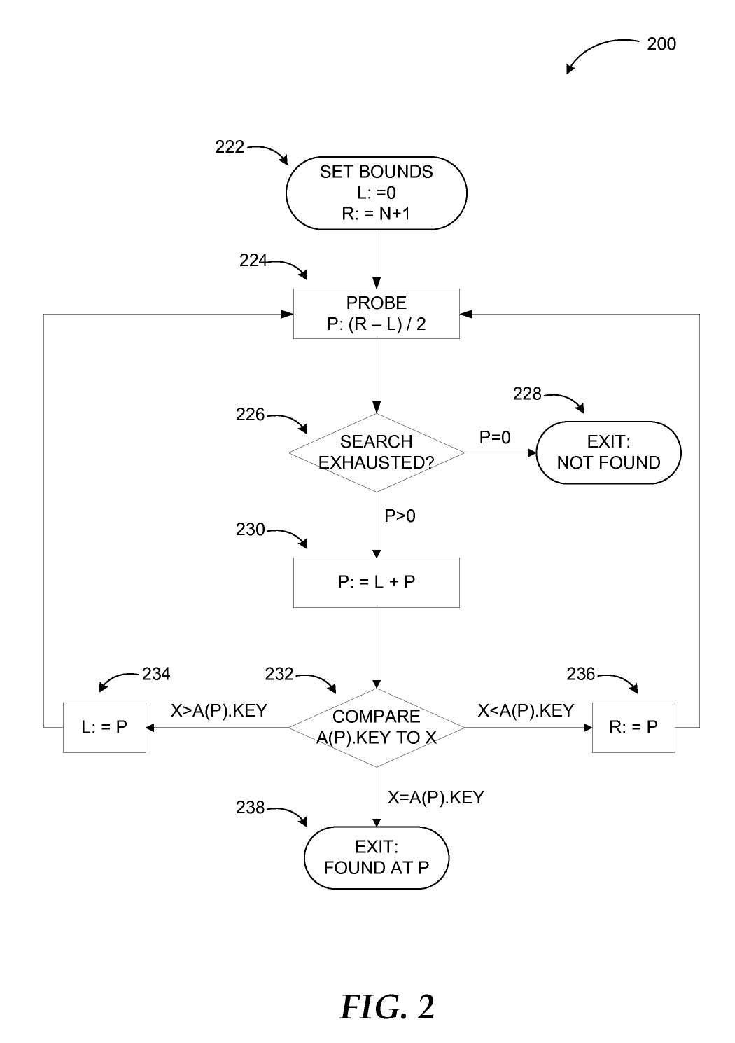

FIG. 2 illustrates flowchart 200 of an example binary search algorithm that fails, when the data is unsorted. In illustrating binary search, a data structure represented by array A is assumed, in which individual elements are identified as A(1), A(2), . . . ,A(N) and they may be accessed in any order. The data structure contains a sub-element or data field called Key, and the array is ordered so that the successive values A(1).Key≦A(2).Key and so on. The requirement is that for a value x, an index p is to be found such that A(p).Key=x.

At the start of the search process, the range to be searched is the list of elements, as marked by variables L and R, and their values are modified with every iteration of the search process. It should be noted that the division by two is integer division, with any remainder lost, so that 3/2 results in 1. The search finishes either because the value has been found or the specified value is not in the list.

At operation 222, the boundaries L and R are initialized (0 and N+1) followed by halving that number (with integer division) at operation 224. If there is at least one element in the range, then p=1 (or more). If no element exists in the range, then p=0 as determined in decision operation 226. In the latter case the method terminates as no element is found (228). Otherwise, for p>0, the search continues at operation 230 where p is set to p:=L+p, which is within the bounds (L+1) to (R−1).

x is compared to A(p).Key at decision operation 232. If x=A(p).Key, then the method terminates successfully with the element being found at p. If x<A(p).Key, then x will also be less than all later elements of the array all the way to element (R−1) because the array is in sorted order. Accordingly, the value of the right-hand bound index R can be changed to be the value p at operation 236. If x is to be found, it will be amongst elements earlier than p, that is (p−1) and earlier. Thus, the iterative process returns to operation 224 for another halving of the range. If x>A(p).Key, the value of L is changed similarly at operation 234 and the iterative process returned to operation 224 for another halving of the range. Whichever boundary is modified, the range remaining to be searched is reduced. If L is changed, it is changed to a higher number (at least L+1), whereas if R is changed, it is to a lower number (at most R−1) because those are the limits for p.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

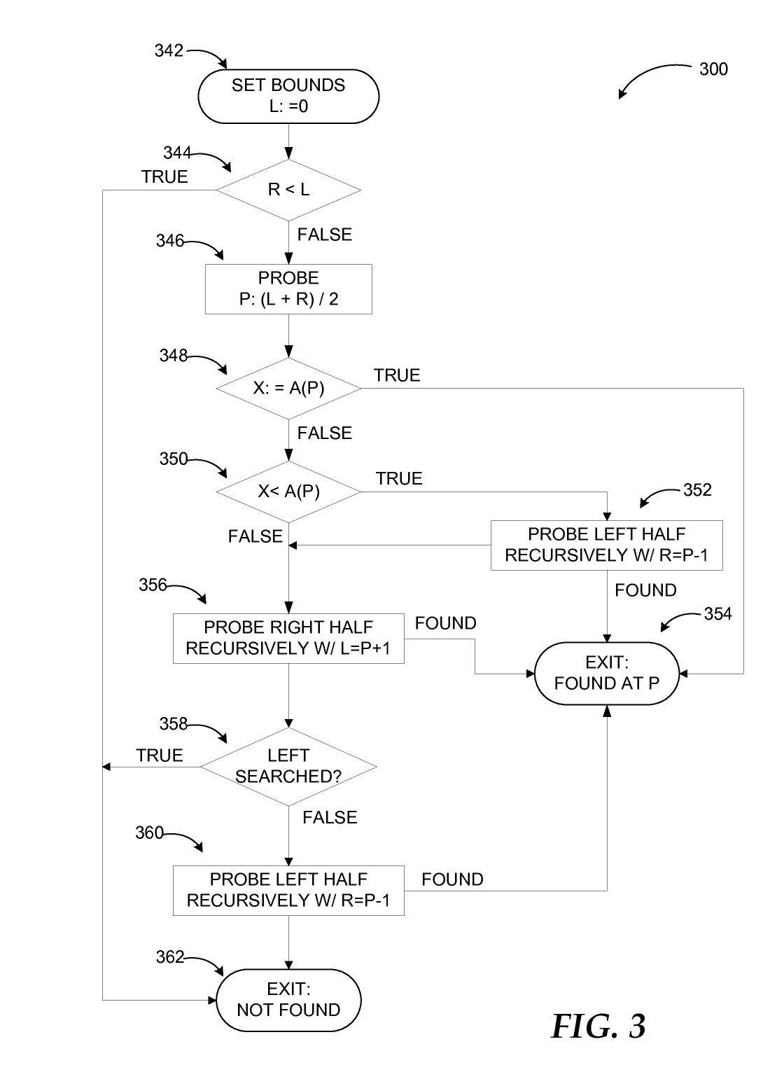

FIG. 3 illustrates flowchart 300 of a range inclusive probe search process according to embodiments. The assumption for a range inclusive probe algorithm shown in flowchart 300 is an array A in which individual elements are identified as A(1), A(2), . . . ,A(N). The elements may be accessed arbitrarily and the array may be sorted or unsorted. The search requirement is that for a value x, find an index p be found such that A(p)=x. As in the previous example, the division here is integer division, with any remainder lost.

The initial span is the full supplied list of elements. Thus, the boundaries are set with L=0 at start operation 342. The range is marked by variables L and R. Their values are changed with each iteration of the search process. At decision operation 344, a determination is made whether there is something to search (R<L), which is to say whether there are any elements in the search span [L, R]. If there are none, the process ends with no element found at operation 362.

At operation 346, the current element to probe is set to the middle one of the span p=L+(R−L)/2. This is followed by the decision operation 348, where a determination is made whether the current value A(p) is equal to x. If the current value is x, then the process ends successfully with the value being found at p in operation 354. On the other hand, if A(P0 is not equal to x, then the next span of recursion is either the left side of the array or the right side of it. In a sorted array, the left side contains elements that are smaller or the same as A(p). Thus, the algorithm probes the left side if x<A(p) and the right side otherwise as shown in operations 350, 352, and 356.

This far, the range inclusive probe algorithm is similar to a binary search. The binary search terminates lookup at this point regardless the x value was found or not. The range inclusive probe algorithm, however, continues the search and eventually probes all elements of the array if necessary. This is illustrated with decision operation 358 and operation 360. If the x value was not found on the left side, then the search continues in the right side. If the value was not found on the right side and it was not searched on the left side, the search continues on the left side. The search finishes either because the value has been found, or else, the value is not in the list.

The operations included in process 300 are for illustration purposes. A range inclusive probe algorithm according to embodiments may be implemented by similar processes with fewer or additional steps, as well as in different order of operations using the principles described herein.

A range inclusive probe algorithm according to algorithms divides a current range in half and chooses the next range according to the binary search rule. If the range is narrowed to a particular element and it is not the lookup value, then the algorithm takes neighboring previously rejected range. The algorithm follows the binary search range reduction and occasionally recurs when the binary search is unsuccessful. If the array is fairly sorted (e.g. few elements are swapped), this lookup order gives enhanced performance. It first verifies ranges neighboring to the most probable one.

In sorted arrays, the range inclusive probe algorithm has the same O(log n) time and O(1) space complexity as a binary search. In a randomly unsorted list, the random inclusive probe algorithm has the same O(n) time and O(1) space complexity as a linear search.

There are classes of partially sorted data where the range inclusive probe algorithm might work much faster than linear search. These classes are common in programming. The binary search cannot be used for fairly sorted data because the binary search assumes a truly sorted list. The linear search, on the other hand, is slow. Thus the range inclusive probe search provides a fast lookup and confidence.

Examples of a fairly sorted list include a list of string literals entered by a human in a sorted order. The list is supposedly sorted, but it may have a swapped entry that the human may not notice. For example, the following list has the second and third entries in incorrect order:

1. “Visual Basic 2008”

2. “Visual C++ 2008”

3. “Visual C#2008”

4. “Visual Studio 2008”

5. “Visual Studio 2008 SDK 1.1”

Moreover, any textually sorted data has to be treated as fairly sorted in many cases. Sorting strings depends on the sort rules used to compare, and, therefore, order pairs of strings. A sort performs a culture-sensitive comparison of strings in which certain characters may have special weights assigned to them. For example, the hyphen (“-”) may have a very small weight assigned to it so that “coop” and “co-op” appear next to each other in a sorted list.

If the sorting rules at the sorting time and the rules at the lookup time do not match, then the binary search might fail. The range inclusive probe algorithm is as confident as the linear search, but it is much faster in such cases.

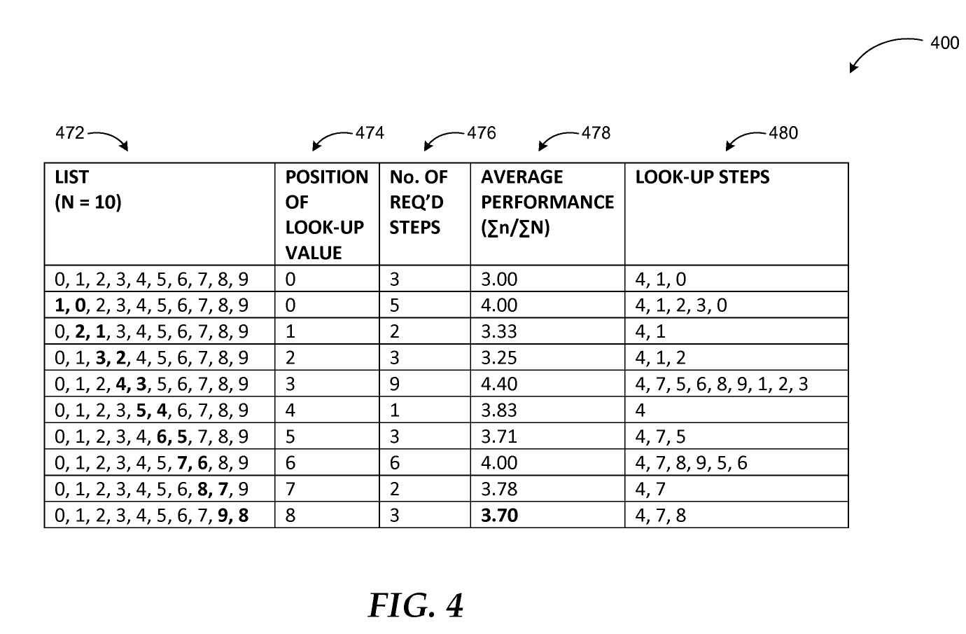

FIG. 4 includes example table 400 illustrating lookup of an element with value “0” in a list of 10 integers employing a range inclusive probe algorithm according to embodiments. In table 400, first column 472 includes the list of 10 elements. The data is partially sorted. Every row has an element swapped with a neighbor. The lookup value is the index of a row.

Position of the lookup value, number of steps taken by the algorithm to find the lookup value, and average performance for each row are listed in columns 474, 476, and 478. Last column 480 lists the lookup steps as the algorithm goes through the elements of each array. The average performance over the 10 permutations of the array shown in table 400 is 3.70 steps. This can be compared to 5.5 steps of a linear search algorithm. As discussed above, a strictly binary algorithm cannot perform the search successfully in partially sorted arrays. If the data is expanded to 100 elements or more, the performance improvement of the range inclusive probe over linear search algorithm markedly grows.

While the example data and processes have been described with specific elements and steps, embodiments are not limited to the example data arrays, algorithm steps, and configurations. An application employing a range inclusive probe algorithm to perform searches through sorted, partially sorted, or unsorted data may be implemented in other systems and configurations using other aspects of speech synthesis using the principles described herein.

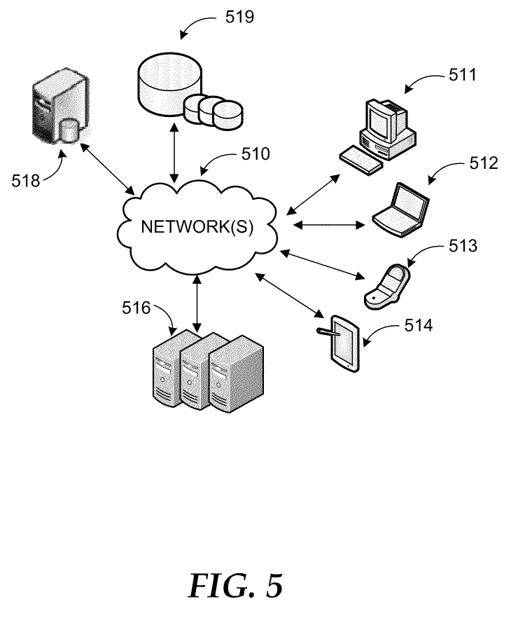

FIG. 5 is an example networked environment, where embodiments may be implemented. A range inclusive probe algorithm may be implemented via software executed in individual client devices 511 through 514 or over one or more servers 516 such as a hosted service. The system may facilitate communications between client applications on individual computing devices (client devices 511-514) for a user through network(s) 510.

Client devices 511-514 may execute any application that performs a search through sorted, partially sorted, or unsorted data as part of the execution of the application. To perform the search, client device 511-514 may perform a range inclusive probe algorithm as described above. Alternatively, the search (along with other parts of the application) may be performed by a server (e.g. one of the servers 516) in communication with the client device. Data associated with the search to be performed may be stored in one or more data stores (e.g. data stores 519), which may be managed by any one of the servers 516 or by database server 518.

A method for performing a search employing a range inclusive probe algorithm, according to embodiments includes determining a search value to be found within an array stored in a data store, determining range boundaries for the search within the array at a processor, performing an iterative search for the value to be found by narrowing the range through halving the range and searching one half at each iteration, and continuing the search in previously unsearched halves of the range if the range is narrowed to a single element of the array and the value not found. The half of the range to be searched at each iteration may be determined based on a binary search criterion. The range boundaries for an initial range may include the complete array. The method may further include determining an existence of searchable elements within the array prior to beginning the search.

A time complexity of the range inclusive probe algorithm is O(log n) for sorted data and near O(log n) for partially sorted data similar to a binary search algorithm. The time complexity is O(n) for randomly unsorted data similar to a linear search algorithm. The space complexity is O(1) for all three types of data. The search is continued in the previously unsearched halves of the range by prioritizing range halves neighboring an already searched highly probable range half The array to be searched may include strings of characters, which are subject to sort rules for comparing and ordering pairs of strings based on a language associated with the characters. Moreover, a special weight may be assigned to selected characters based on the language.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement an application employing a range inclusive probe algorithm to perform searches through various types of data. Furthermore, the networked environments discussed in FIG. 5 are for illustration purposes only. Embodiments are not limited to the example applications, modules, or processes.

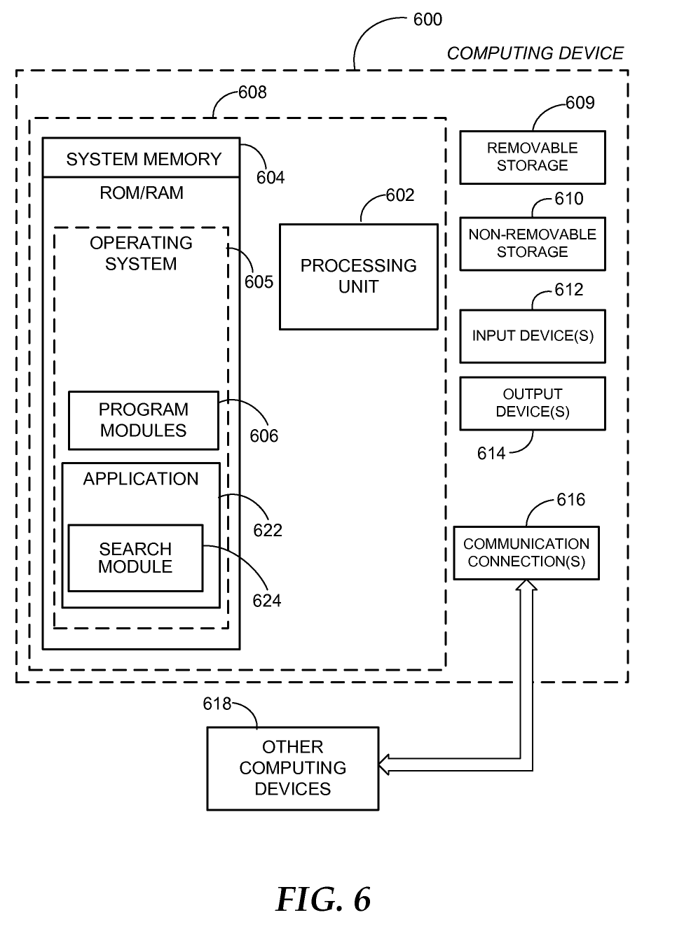

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS (operating systems from MICROSOFT CORPORATION of Redmond, Wash. The system memory 604 may also include one or more software applications such as program modules 606, application 622, and search module 624.

Application 622 may be a standalone application or part of a networked service that performs searches through sorted, partially sorted, or unsorted data as part of its execution. Search module 624, which may perform those searches employing a range inclusive probe algorithm as discussed previously. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for performing a search employing a range inclusive probe algorithm, the method comprising:
determining a search value to be found within an array stored in a data store;
determining range boundaries for the search within the array at a processor;
performing an iterative search for the value to be found by narrowing the range through halving the range and searching one half at each iteration; and
if the range is narrowed to a single element of the array and the value not found, continuing the search in previously unsearched halves of the range.

2. The method of claim 1, further comprising:
if the value is found returning a value found result; else
returning a value not found result.

3. The method of claim 1, wherein the array includes one of: sorted data, partially sorted data, and unsorted data.

4. The method of claim 1, wherein the one half of the range to be searched at each iteration is determined based on a binary search criterion.

5. The method of claim 1, wherein the range is halved through integer division with a remainder of the division being dropped.

6. The method of claim 1, wherein the range boundaries for an initial range include the complete array.

7. The method of claim 1, wherein a time complexity of the range inclusive probe algorithm is O(log n) for sorted data, near O(log n) for partially sorted data, and O(n) for randomly unsorted data, n being a number of elements in the array.

8. The method of claim 1, wherein a space complexity of the range inclusive probe algorithm is O(1) for sorted data, partially sorted data, and unsorted data.

9. The method of claim 1, wherein continuing the search in the previously unsearched halves of the range includes prioritizing range halves neighboring an already searched highly probable range half.

10. A computer-readable storage medium with instructions stored thereon for performing a search employing a range inclusive probe algorithm, the instructions comprising:
determining a search index, p, to be found within an array A stored in a data store for a value, x, such that A(p)=x, wherein elements A(1) through A(N) are one of: sorted data, partially sorted data, and unsorted data;
setting an initial search range boundaries [L, R] for the search to include a complete set of A's elements at a processor;
performing an iterative search for the value to be found by:
narrowing the initial search range through integer division of the range during each iteration such that p=L+(R−L)/2;
if a current value A(p)=x, returning a successfully found result;
if a current value A(p)≠x, continuing to search one of a left neighboring range and right neighboring range depending on whether x<A(p); and
if A(p)=x is not found and the iterated ranges are exhausted, beginning an element by element search of previously unsearched half ranges.

11. The computer-readable medium of claim 10, wherein the elements of A include strings of characters.

12. The computer-readable medium of claim 11, wherein the search is performed based on predefined sort rules for comparing and ordering pairs of strings.

13. The computer-readable medium of claim 12, wherein the sort rules are language sensitive and include special weights assigned to selected characters.

14. The computer-readable medium of claim 10, wherein the elements of A are arbitrarily accessible.

15. The computer-readable medium of claim 10, wherein the instructions further include eliminating a remainder of division p=L+(R−L)/2 for determining a new search range at each iteration.

16. A computing device for executing an application capable of performing a range inclusive probe algorithm to search, the computing device comprising:
a memory storing an array to be searched;
a processor coupled to the memory, the processor executing an application configured to:
determine a search value to be found within elements of the array, wherein the elements include one of: sorted data, partially sorted data, and unsorted data;
determine boundaries for an initial range of the search within the array;
perform an iterative search for the value by;
dividing the initial range in half,
selecting one of two segments of the initial range;
searching through the selected segment;
if the sought value is not found, continuing iterative process of halving a searched segment and searching one of the halves until one of: the sought value is found and not found; and
if the sought value is not found within searched half segments, continuing to search previously unsearched segments of the range by prioritizing range segments neighboring an already searched highly probable range segment.

17. The computing device of claim 16, wherein the array includes strings of characters subject to distinct sorting rules based on a language of the application.

18. The computing device of claim 17, wherein a prioritization of range segments is determined depending on the language based sorting rules.

19. The computing device of claim 18, wherein a time complexity of the range inclusive probe algorithm approaches that of a binary search algorithm for sorted and partially sorted data, and that of a linear search for randomly unsorted data.

20. The computing device of claim 16, wherein application is further configured to determine an existence of searchable elements within the array prior to beginning the search.
